(19) United States
(12) Patent Application Publication
(10) Pub. No.: US 2006/0045829 A1
(43) Pub. Date: Mar. 2, 2006

(54) Process for the removal of heavy metals from gases, and compositions therefor and therewith

(76) Inventors: Glenn W. Dodwell, Bartlesville, OK (US); Joseph B. Cross, Bartlesville, OK (US); Marvin M. Johnson, Bartlesville, OK (US)

Correspondence Address: RICHMOND, HITCHCOCK, FISH & DOLLAR, P.O. Box 2443, Bartlesville, OK, 74005, US

(21) Appl. No.: 10/926,940

(22) Filed: Aug. 26, 2004

(51) Int. Cl. B01J 20/20

(52) U.S. Cl. 423/210; 502/406

(57) ABSTRACT

A composition containing ferrous sulfate and/or ferric sulfate and amorphous carbon is disclosed. A method of preparing such composition is also disclosed. The composition is employed in a process to remove a heavy metal from a gaseous feed stream which can optionally include a separate heavy metal adsorption stage.

The invention relates to a composition useful in the removal of heavy metals from a gaseous feed stream. In one aspect the invention relates to a method of preparing such composition. In yet another aspect the invention relates to a process for removing heavy metals from a gas stream using the inventive composition and, optionally, a second stage adsorption of the heavy metal.

### BACKGROUND OF THE INVENTION

Heavy metals are released during the combustion process of many fossil fuels and/or waste materials. These heavy metals include, for example, arsenic, beryllium, lead, cadmium, chromium, nickel, zinc, mercury and barium. Most of these heavy metals are toxic to humans and animals. In particular, lead is thought to compromise the health and mental acuity of young children and fetuses.

Furthermore, there is every indication that the amount of mercury, and possibly of other heavy metals, now legally allowed to be released by those combusting various fossil fuels and/or waste materials, including coal burning powerplants, and petroleum refineries, will be reduced by future legislation. While a variety of adsorbents are available for capture of heavy metals (in particular mercury), these adsorbents tend to have low capacities and are easily deactivated by other components in the gas stream, such as sulfur oxides and nitrogen oxides. We have discovered a material that converts an elemental heavy metal to an oxidation state greater than zero, even in the presence of sulfur oxides and nitrogen oxides.

### SUMMARY OF THE INVENTION

It is an object of this invention to provide an improved iron material which when used in the removal of heavy metal results in oxidation of the heavy metal to an oxidation state greater than zero, even in the presence of sulfur oxides and nitrogen oxides.

A further object of this invention is to provide a method for making an improved iron material which when used in the removal of heavy metal results in oxidation of the heavy metal to an oxidation state greater than zero, even in the presence of sulfur oxides and nitrogen oxides.

Another object of this invention is to provide an improved process for the removal of heavy metal from a heavy metal-containing gas which results in oxidation of the heavy metal to an oxidation state greater than zero, even in the presence of sulfur oxides and nitrogen oxides, with an optional second stage for adsorption of oxidized heavy metal.

In accordance with a first embodiment of the invention, the inventive composition consists essentially of ferric sulfate and amorphous carbon.

In accordance with a second embodiment of the invention, the inventive composition can be prepared by the method of:
a) contacting amorphous carbon with an aqueous solution comprising an iron sulfate and an acid to form promoted amorphous carbon; and
b) drying the promoted amorphous carbon under drying conditions to form the composition.

In accordance with a third embodiment of the invention, the inventive composition can be used in the removal of heavy metal from a gaseous feed stream comprising heavy metal by contacting, under heavy metal removal conditions, the gaseous feed stream with any of the inventive compositions of embodiments one and two above.

Other objects and advantages of the invention will become apparent from the detailed description and the appended claims.

### DETAILED DESCRIPTION OF THE INVENTION

In accordance with the first embodiment of the present invention, an inventive composition consists essentially of ferric sulfate (Fe₂(SO₄)₃ or Fe₂(SO₄)₃-9H₂O) and amorphous carbon.

The ferric sulfate (as Fe₂(SO₄)₃) is present in said composition, in an amount in the range of from about 1 to about 20 weight %, preferably from about 1 to about 15 weight %, and most preferably from about 2 to about 10 weight %, based on the total weight of the composition.

The amorphous carbon is preferably selected from the group consisting of activated carbon, activated charcoal, and combinations thereof.

In accordance with the second embodiment of the present invention, an inventive composition can be prepared by the method of, and a method is provided including:
a) contacting amorphous carbon with an aqueous solution comprising an iron sulfate and an acid to form promoted amorphous carbon; and
b) drying the promoted amorphous carbon under drying conditions to form the composition.

The iron sulfate can be selected from the group consisting of ferrous sulfate, ferric sulfate, and combinations thereof. Preferably, the iron sulfate is ferric sulfate.

The acid can be any acid capable of providing an acidic environment. Preferably, the acid is sulfuric acid. The drying conditions include a temperature in the range of from about 90° C. to about 130° C.; preferably from about 100° C. to about 120° C.; and a drying time in the range of from about 1 to about 6 hours; preferably from about 2 to about 4 hours.

In accordance with the third embodiment of the present invention, the inventive composition can be used in the removal of heavy metal from a gaseous feed stream comprising heavy metal by a process comprising, consisting of, or consisting essentially of contacting, in a contacting zone, under heavy metal removal conditions, the gaseous feed stream with any of the inventive compositions, and combinations thereof, of embodiments one through two above. A gaseous product stream is withdrawn from the contacting zone. The gaseous feed stream is typically a combustion gas; and is more typically a stack gas derived from the combustion of coal. The gaseous feed stream can also further comprise compounds selected from the group consisting of sulfur oxides, CO₂, water, nitrogen oxides, HCl, and combinations of any two or more thereof.

The contacting of the gaseous feed stream with the inventive composition is preferably carried out at a temperature in the range of from about 75 to about 300° C., more preferably from about 100 to about 250° C., and most preferably from about 115 to about 175° C.

The heavy metal typically comprises a metal selected from the group consisting of arsenic, beryllium, lead, cadmium, chromium, nickel, zinc, mercury, barium, and combinations of any two or more thereof. The heavy metal most typically comprises mercury.

When the heavy metal is mercury, the mercury is typically present in the gaseous feed stream in an amount in the range of from about 0.1 to about 10,000 μg/m³, more typically in the range of from about 1 to about 800 μg/m³ and most typically from about 3 to about 700 μg/m³.

The composition preferably converts at least a portion of the heavy metal in the gaseous feed stream to an elevated oxidation state. In the case of mercury, the composition preferably converts at least a portion of the mercury contained in the gaseous feed stream from a zero oxidation state to a +1 or a +2 oxidation state and also preferably removes mercury. “At least a portion”, as used in this paragraph, can mean at least 20 weight %, preferably at least 30 weight %, and more preferably at least 50 weight % mercury based on the total amount of mercury contained in the gaseous feed stream.

The gaseous product stream preferably contains less than about 80 weight %, more preferably less than about 90 weight %, and most preferably less than about 95 weight % of the mercury contained in the gaseous feed stream.

The gaseous product stream is optionally contacted with a separate adsorbent in an adsorption zone. The adsorbent can be any adsorbent capable of adsorbing a heavy metal. More preferably, the adsorbent comprises, consists of or consists essentially of a material selected from the group consisting of a zeolite, amorphous carbon, and combinations thereof. The amorphous carbon can be an activated carbon or an activated charcoal. A treated gaseous product stream is withdrawn from the adsorption zone and contains less than 80 weight %, preferably less than 90 weight %, and more preferably less than 95 weight % of the heavy metal contained in the gaseous feed stream.

The following examples are presented to further illustrate this invention and are not to be construed as unduly limiting its scope.

### EXAMPLE 1

This example illustrates the preparation of compositions which were subsequently tested for their ability to remove mercury from a gaseous feed stream comprising mercury.

### Inventive Composition

Approximately 2 grams of Fe₂(SO₄)₃ was dissolved into approximately 20 ml of an aqueous mixture containing 4 wt. % sulfuric acid to form an impregnation solution. A 20 gram quantity of activated charcoal (3 mm extrudates), obtained from Mead Westvaco under product designation NuChar Bx-7530 activated carbon, was impregnated, by incipient wetness, with the impregnation solution. The activated charcoal had been crushed and sieved to 20/40 mesh prior to impregnating with the impregnation solution. The impregnated material was then dried at about 110° C. for around 90 minutes. The composition contained about 4.73 wt. % Fe₂ (SO₄)₃, based on the total weight of the composition as prepared.

### Evaluation of Sorbents for Mercury Removal

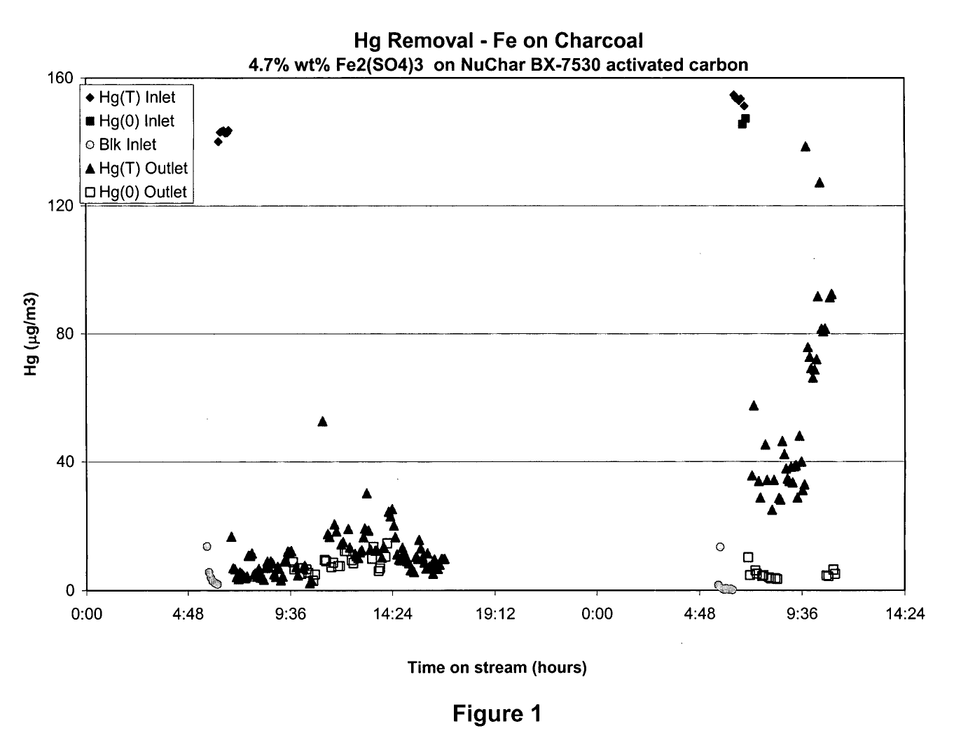

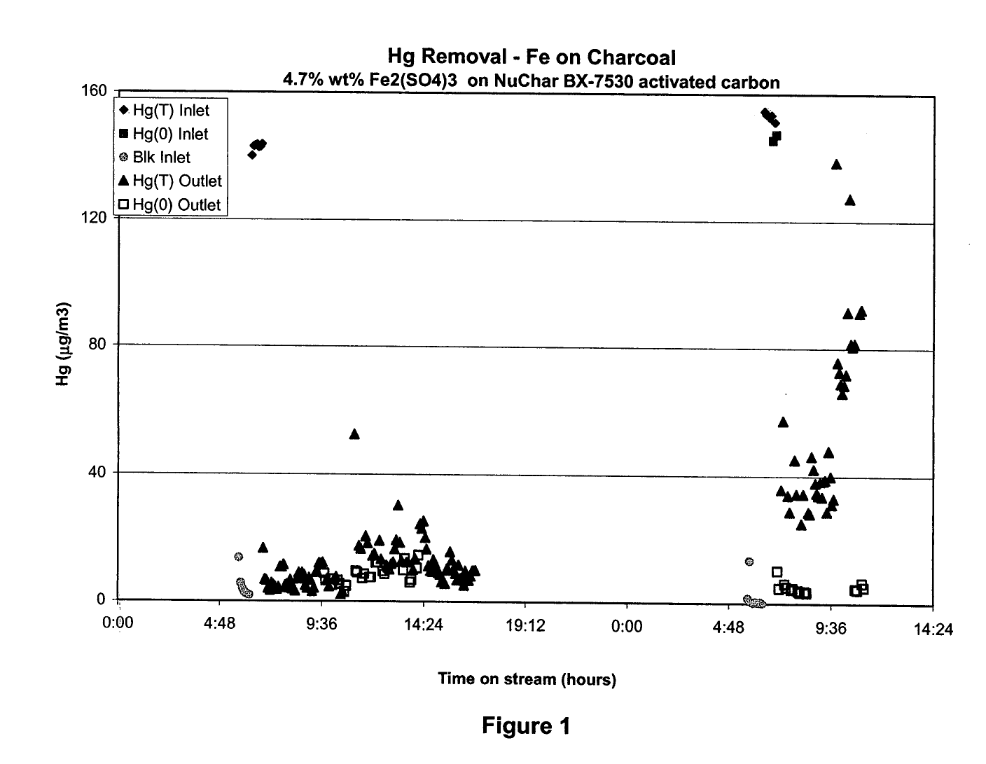

The inventive composition was tested in a fixed bed reactor set at 110° C. with a flue gas blend consisting of ˜82.5 vol. % N₂, ˜4.7 vol. % O₂, ˜2.6 vol. % CO₂, ˜10 vol. % H₂O, ˜450 ppmv SO₂, ˜10 ppmv NO₂, ˜110 ppmv NO, and ˜20 ppmv HCl. Elemental mercury, from a mercury permeation tube, was entrained into the flue gas blend. The weight of the catalyst in the reactor bed was 0.0896 g, with a density of ˜0.33 grams/cc. The total gas flow rate through the reactor was 650 ml/min, yielding a gas hourly space velocity of ˜144,000 hr.⁻¹. The mercury level (both Hg(0) and Hg (Total)) at the inlet and outlet of the reactors was measured to determine the amount of mercury removed by the composition and the amount of mercury that was oxidized and that broke through the catalyst bed. The data is shown in FIG. 1.

As is apparent from FIG. 1, at the initial stage of the run, the inventive composition removed the mercury from the system with an efficiency of >95%. The flue gas blend was allowed to flow through the reactor overnight, but with the analyzer system turned off. At the outset of day 2 of the run, the Hg(Total) values indicated that the material was experiencing breakthrough for mercury removal, however the Hg(0) values remained at baseline, demonstrating that even though the inventive composition had reached its capacity for uptake of mercury, it was still effectively oxidizing the elemental mercury to Hg (+1 or +2) and most likely forming mercury compounds, such as HgS, HgO or HgCl₂.

That which is claimed is:

1. A composition consisting essentially of ferric sulfate and amorphous carbon.

2. A composition in accordance with claim 1 wherein said amorphous carbon is an activated carbon.

3. A composition in accordance with claim 1 wherein said amorphous carbon is an activated charcoal.

4. A composition in accordance with claim 1 wherein said ferric sulfate is present in said composition in an amount in the range of from about 1 to about 20 weight percent, based on the total weight of said composition.

5. A composition in accordance with claim 1 wherein said ferric sulfate is present in said composition in an amount in the range of from about 1 to about 15 weight percent, based on the total weight of said composition.

6. A composition in accordance with claim 1 wherein said ferric sulfate is present in said composition in an amount in the range of from about 2 to about 10 weight percent, based on the total weight of said composition.

7. A method of preparing a composition comprising:
a) contacting amorphous carbon with an aqueous solution comprising an iron sulfate and an acid to form promoted amorphous carbon; and
b) drying said promoted amorphous carbon under drying conditions to form said composition.

8. A method in accordance with claim 7 wherein said amorphous carbon is an activated carbon.

9. A method in accordance with claim 7 wherein said amorphous carbon is an activated charcoal.

10. A method in accordance with claim 7 wherein said iron sulfate is ferrous sulfate.

11. A method in accordance with claim 7 wherein said iron sulfate is ferric sulfate.

12. A method in accordance with claim 7 wherein said acid is sulfuric acid.

13. A method in accordance with claim 7 wherein said drying conditions include a temperature in the range of from about 90° C. to about 130° C. and a drying time in the range of from about 1 to about 6 hours.

14. A method in accordance with claim 7 wherein said drying conditions include a temperature in the range of from about 100° C. to about 120° C. and a drying time in the range of from about 2 to about 4 hours.

15. A composition prepared by a method comprising:
a) contacting amorphous carbon with an aqueous solution comprising an iron sulfate and an acid to form promoted amorphous carbon; and
b) drying said promoted amorphous carbon under drying conditions to form said composition.

16. A process comprising:
a) contacting, in a contacting zone, a gaseous feed stream comprising a heavy metal and oxygen with the composition of claim 1; and
b) withdrawing a gaseous product stream from said contacting zone.

17. A process as recited in claim 16 wherein said gaseous product stream contains less heavy metal than said gaseous feed stream.

18. A process as recited in claim 16 wherein said gaseous feed stream further comprises a compound selected from the group consisting of sulfur oxides, CO₂, water, nitrogen oxides, HCl, and combinations of any two or more thereof.

19. A process as recited in claim 16 wherein said gaseous feed stream is a combustion gas.

20. A process as recited in claim 16 wherein said gaseous feed stream is a stack gas derived from the combustion of coal.

21. A process as recited in claim 16 wherein said contacting is carried out at a temperature in the range of from about 75 to about 300° C.

22. A process as recited in claim 16 wherein said contacting is carried out at a temperature in the range of from about 100 to about 250° C.

23. A process as recited in claim 16 wherein said contacting is carried out at a temperature in the range of from about 115 to about 175° C.

24. A process as recited in claim 16 wherein said heavy metal comprises a metal selected from the group consisting of arsenic, beryllium, lead, cadmium, chromium, nickel, zinc, mercury, barium, and combinations of any two or more thereof.

25. A process as recited in claim 24 wherein said heavy metal is mercury.

26. A process as recited in claim 25 wherein said composition converts at least a portion of said mercury in said gaseous feed stream from a zero oxidation state to a +1 or a +2 oxidation state.

27. A process as recited in claim 25 wherein said mercury is present in said gaseous feed stream in an amount in the range of from about 0.1 to about 10,000 μg/m³.

28. A process as recited in claim 25 wherein said mercury is present in said gaseous feed stream in an amount in the range of from about 1 to about 800 μg/m³.

29. A process as recited in claim 25 wherein said mercury is present in said gaseous feed stream in an amount in the range of from about 3 to about 700 μg/m³.

30. A process as recited in claim 25 wherein said gaseous product stream contains less than about 80 weight % of the mercury contained in said gaseous feed stream.

31. A process as recited in claim 25 wherein said gaseous product stream contains less than about 90 weight % of the mercury contained in said gaseous feed stream.

32. A process as recited in claim 25 wherein said gaseous product stream contains less than about 95 weight % of the mercury contained in said gaseous feed stream.

33. A process as recited in claim 16 wherein said gaseous product stream is contacted, in an adsorption zone, with an adsorbent selected from the group consisting of a zeolite, amorphous carbon, and combinations thereof.

34. A process as recited in claim 33 wherein said composition oxidizes at least a portion of said heavy metal in said gaseous feed stream to an elevated oxidation state.

35. A process as recited in claim 33 wherein said heavy metal is mercury and wherein said composition oxidizes at least a portion of said mercury in said gaseous feed stream from a zero oxidation state to a +1 or a +2 oxidation state.

36. A process as recited in claim 33 wherein a treated gaseous product stream is withdrawn from said adsorption zone, and wherein said treated gaseous product stream contains less than about 80 weight % of the heavy metal contained in the gaseous feed stream.

37. A process as recited in claim 33 wherein a treated gaseous product stream is withdrawn from said adsorption zone, and wherein said treated gaseous product stream contains less than about 90 weight % of the heavy metal contained in the gaseous feed stream.

38. A process as recited in claim 33 wherein a treated gaseous product stream is withdrawn from said adsorption zone, and wherein said treated gaseous product stream contains less than about 95 weight % of the heavy metal contained in the gaseous feed stream.

39. A process comprising:
a) contacting, in a contacting zone, a gaseous feed stream comprising a heavy metal and oxygen with the composition of claim 15; and
b) withdrawing a gaseous product stream from said contacting zone.

40. A process as recited in claim 39 wherein said gaseous product stream contains less heavy metal than said gaseous feed stream.

41. A process as recited in claim 39 wherein said gaseous feed stream further comprises a compound selected from the group consisting of sulfur oxides, CO₂, water, nitrogen oxides, HCl, and combinations of any two or more thereof.

42. A process as recited in claim 39 wherein said gaseous feed stream is a combustion gas.

43. A process as recited in claim 39 wherein said gaseous feed stream is a stack gas derived from the combustion of coal.

44. A process as recited in claim 39 wherein said contacting is carried out at a temperature in the range of from about 75 to about 300° C.

45. A process as recited in claim 39 wherein said contacting is carried out at a temperature in the range of from about 100 to about 250° C.

46. A process as recited in claim 39 wherein said contacting is carried out at a temperature in the range of from about 115 to about 175° C.

47. A process as recited in claim 39 wherein said heavy metal comprises a metal selected from the group consisting of arsenic, beryllium, lead, cadmium, chromium, nickel, zinc, mercury, barium, and combinations of any two or more thereof.

48. A process as recited in claim 47 wherein said heavy metal is mercury.

49. A process as recited in claim 48 wherein said composition converts at least a portion of said mercury in said gaseous feed stream from a zero oxidation state to a +1 or a +2 oxidation state.

50. A process as recited in claim 48 wherein said mercury is present in said gaseous feed stream in an amount in the range of from about 0.1 to about 10,000 μg/m³.

51. A process as recited in claim 48 wherein said mercury is present in said gaseous feed stream in an amount in the range of from about 1 to about 800 μg/m³.

52. A process as recited in claim 48 wherein said mercury is present in said gaseous feed stream in an amount in the range of from about 3 to about 700 μg/m³.

53. A process as recited in claim 48 wherein said gaseous product stream contains less than about 80 weight % of the mercury contained in said gaseous feed stream.

54. A process as recited in claim 48 wherein said gaseous product stream contains less than about 90 weight % of the mercury contained in said gaseous feed stream.

55. A process as recited in claim 48 wherein said gaseous product stream contains less than about 95 weight % of the mercury contained in said gaseous feed stream.

56. A process as recited in claim 39 wherein said gaseous product stream is contacted, in an adsorption zone, with an adsorbent selected from the group consisting of a zeolite, amorphous carbon, and combinations thereof.

57. A process as recited in claim 56 wherein said composition oxidizes at least a portion of said heavy metal in said gaseous feed stream to an elevated oxidation state.

58. A process as recited in claim 56 wherein said heavy metal is mercury and wherein said composition oxidizes at least a portion of said mercury in said gaseous feed stream from a zero oxidation state to a +1 or a +2 oxidation state.

59. A process as recited in claim 56 wherein a treated gaseous product stream is withdrawn from said adsorption zone, and wherein said treated gaseous product stream contains less than about 80 weight % of the heavy metal contained in the gaseous feed stream.

60. A process as recited in claim 56 wherein a treated gaseous product stream is withdrawn from said adsorption zone, and wherein said treated gaseous product stream contains less than about 90 weight % of the heavy metal contained in the gaseous feed stream.

61. A process as recited in claim 56 wherein a treated gaseous product stream is withdrawn from said adsorption zone, and wherein said treated gaseous product stream contains less than about 95 weight % of the heavy metal contained in the gaseous feed stream.
